(19) United States
(12) Patent Application Publication
(10) Pub. No.: US 2024/0189831 A1
(43) Pub. Date: Jun. 13, 2024

(54) PRETREATMENT METHOD FOR UTILIZATION OF COAL ASH LANDFILLED IN ASH PONDS

(71) Applicant: NATIONAL INSTITUTE OF ENVIRONMENTAL RESEARCH, Incheon (KR)

(72) Inventors: Namil UM, Incheon (KR); Young Yeul KANG, Incheon (KR); Cheol Woo YOON, Incheon (KR); Soo Yeon HONG, Incheon (KR); Na Hyeon CHO, Incheon (KR); Min-Jung KIM, Gyeonggi-do (KR); Ja-Hyung CHOI, Incheon (KR); Tae Wan JEON, Gyeonggi-do (KR); Young Sam YOON, Gyeonggi-do (KR)

(21) Appl. No.: 17/784,970

(22) PCT Filed: Mar. 7, 2022
(86) PCT No.: PCT/KR2022/003144

§ 371 Date: Jun. 13, 2022

(30) Foreign Application Priority Data
Feb. 18, 2022 (KR) 10-2022-0021349

(51) Int. Cl. B03B 5/30; B03B 9/04; B03C 1/005; B09B 3/35

(52) U.S. Cl. CPC B03B 5/30; B03B 9/04; B03C 1/005; B09B 3/35

(57) ABSTRACT

Disclosed is a pretreatment method for utilization of coal pond ash (coal ash buried in ash ponds near coal-fired power plants), and more specifically a treatment method of coal pond ash capable of utilizing coal ash with high efficiency through simple separation processes including screening, float-sink, flotation, grinding, and magnetic separation.

### TECHNICAL FIELD

The present invention relates to a pretreatment method for utilization of coal pond ash, and more particularly to a treatment method of coal pond ash capable of utilizing coal pond ash with high efficiency through simple separation processes including screening, float-sink, flotation, grinding, and magnetic separation.

### BACKGROUND ART

Coal ash (CA) is inorganic waste that remains unburned in the furnaces of coal-fired power plants (CPPs). It is broadly classified into fly ash (collected from electrostatic precipitators) and bottom ash (collected from the bottom of boilers). Coal ash has a broad particle size range from less than 0.1 μm to greater than 5 cm in diameter, and is composed mainly of silicon dioxide (SiO₂), aluminum oxide (Al₂O₃), iron oxide (Fe₂O₃), calcium oxide (CaO), and magnesium oxide (MgO) (Lee S. et al., Renew. Sust. Energy Rev. 50, 186-193, 2015; Liang W. et al., J. Energy Inst. 93, 642-648, 2020). Coal ash has been used as a recyclable material in industrial fields, and may play an essential role as a new alternative resource. For this reason, many countries are making a lot of policy efforts to replace coal ash with new resources. In Korea, in order to promote increased efficiency of recycling of coal ash, it has been designated a recyclable byproduct in the ‘Act on the Promotion of Saving and Recycling of Resources’ announced by the Ministry of Environment (Ministry of Environment, 2020). Moreover, a list of recyclable items for coal ash that may be approved by the government without the need for any permission was provided in the ‘Guideline for Recycling of Steel Slag and Coal Ash Producers (Notification No. 2016-217, Ministry of Environment) (Ministry of Environment, 2016)’. The list includes 16 items: concrete admixtures such as ready-mixed concrete, cement, lightweight aggregates, secondary cement products, embankments, covers, road aggregates, wood adhesives, cement clinkers, drainage layers, ceramics, rubbers, plastic fillers, paint/abrasive/insulation materials, steel-making materials, and topsoil fertilizers. In the United States, laws and regulations regarding coal ash vary from one state to another. The Pennsylvania Department of Environmental Protection developed “Beneficial Use of Coal Ash” under the Solid Waste Management Act (Department of Environmental Protection, 2021). In Europe, the use of coal ash is controlled by the Directive 2008/98/EC enacted to improve the management of waste, including coal ash, and to promote reuse and recycling (European Union Law, 2008). Japan is currently focusing on ensuring the quality and environmental safety of recycled products to increase the efficiency of coal ash recycling. Responsibility for environmental safety lies with producers, intermediate contractors, and end users (Sato K. et al., 2015. Japanese Geotechnical Society Special Publication 3, 65-70). China has strengthened coal management and established a series of commercial coal quality standards including civil coal standards. Accordingly, central and local governments in China are implementing preferential policies such as funding or tax breaks for projects using coal ash (Bai X. et al., 2017, Int. Geol. Rev. 60, 535-547). In addition, some experts are suggesting the following countermeasures. First, an improved support system led by the government (e.g. road toll waiver, financial loan support, stabilization of recycling markets, and expansion of demand channels for recycled products) is needed to promote the recycling of domestic coal ash (UNDP, 2017, Sustainable Development Goals (Policy Brief Series): Examples of Successful Policies in Waste Management & Lessons Learned in Korea Applicable to Other Countries (Accessed 24 Jun. 2021)). Second, producers have to be made more responsible for the recycling of coal ash (UNEP, 2010). Third, the scope of recyclable items should be expanded (Ministry of Environment, 2016). Fourth, a public-private consultative group including the government, officials from coal-fired power plants, and recycling companies should be established to frequently discuss additional measures to increase the efficiency of recycling of domestic coal ash.

Despite these efforts, however, some types of coal ash depend on particular types of landfill disposal. For example, the amount of coal ash produced in domestic coal-fired power plants in 2017 reached 9.4 million tons (MT), among which the recycled amount thereof was the highest at 8.0 MT (85.1%). However, landfill treatment was 1.4 MT (14.9%), followed by incineration (less than 0.1 MT, <1%) (Um N. et al., 2018. Study on the Performance Improvement of Domestic Management Systems for Effective Control of Transboundary Movement of Waste. National Institute of Environmental Research, Incheon (South Korea)). Also, in the case of recycling, the use of coal ash as an alternative raw material to cement and auxiliary fuel for cement was the highest, at 7.1 MT (88.8%), followed by fillers and coverings (0.4 MT, 5%), bricks (0.2 MT, 2.5%), and other items (0.3 MT, 3.8%), indicating that the recycling of coal ash depends heavily on the cement industry. For example, many studies have been conducted on the use of coal ash in the cement industry, such as for cement resources and concrete aggregates (Mangi S. A. et al., 2019. Resources 8 (2), 99; Navdeep S. et al., 2019. Resour. Conserv. Recycl. 144, 240-251; Qin Q. et al., 2020, Bioresour. Technol. 318, 124055) and reuse for shotcrete and building materials (Anghelescu L. et al., 2019. Constr. Build. Mater. 227, 116616; Kim H. et al., 2009. Mater. Sci. Forum 620-622, 251-254). In addition, the physical properties thereof were investigated for the purpose of recycling cement materials (Rifal A. et al., 2009, Advances in Environmental Geotechnics. Springer, pp. 715-720). This imbalance in research and utilization means that coal ash is included in the list of recyclable items recommended by the government but is difficult to use as a raw material in other recycling fields due to the low quality thereof. Moreover, in order to reduce additional costs for transport, treatment, and facility installation, recycling companies first consider the direct recycling method without any pretreatment process. Ultimately, the physical and chemical compositions (characteristics) of coal ash may not meet the quality standards required for recycled products. These concerns are not limited to Korea. In Europe, only 13 MT of a total of 30 MT of coal ash was recycled in 2016, of which >70% was used as an alternative raw material to cement (raw material, blended cement, and concrete additives) (European Coal Combustion Products Association, 2021). In the United States, only 41 MT of a total of 110 MT of coal ash in 2018 was recycled as a raw material for cement for the manufacture of concrete, concrete products, and grout (EPA, 2021). In China, the overall use of coal ash has been gradually increasing these days, but recycling efficiency remains below 70% due to a drastic increase in the amount of coal ash that is generated, restrictions on transport radius, and low quality of coal ash as a raw material (He et al., 2012).

Coal ash from 11 domestic nuclear power plants (Hadong, Taean, Yeosu, Yeongdong, Yeongheung, Samcheonpo, Donghae, Honam, Dangjin, Seocheon, and Boryeong) is being disposed of in landfills near the coast of each coal-fired power plant. There are approximately 265 sites with coal-fired power plants in the United States, most of which have coal ash landfills (Environmental Integrity Project, 2019). There are 38 coal-fired power plants in Japan. After the Great East Japan Earthquake in 2011, there has been a significant shift from nuclear power generation to thermal power generation, and coal-fired power generation is now playing an important role as a stable power source (Sato K. et al., 2015, Japanese Geotechnical Society Special Publication 3, 65-70). In general, coal ash buried in landfills is composed of a mixture of fly ash and bottom ash. In the case of fly ash, the particles are spherical or sharp and the size distribution thereof is homogeneous because of the fine particle size of less than 0.1 μm, so the properties thereof may be different from those of bottom ash. However, when fly ash is buried, it is mixed with bottom ash, and the two types are not separately treated and buried. As can be seen from the landfill amount, a certain amount of coal ash is expected to be steadily buried at least annually in landfills in the future. Since most landfills are actually full, construction of new landfill sites is essential. However, construction is difficult due to the high cost of constructing landfills and concerns of local residents about the possibility of pollution of the surrounding environment. For example, a report on the amount of land polluted by coal ash across the United States raises questions about the quality of groundwater at each site. It was found that 91% of all sites have unsafe levels, which appear to be affected by neighboring landfills (Environmental Integrity Project, 2019; Vengosh A. et al., 2019, Sci. Total Environ. 686,1090-1103). In the case of Africa, large-scale coal mines are being built in Mozambique, and it is planned to develop a hub of large-scale coal-fired power plants supplying electricity to neighboring countries in Southern Africa. However, these activities increase the possibility of pollution due to coal ash (Marove C. A. et al., 2020, J. Afr. Earth Sci. 168, 103861). In China, coal ash repositories of 14 Chinese power plants were surveyed. The survey found 20 or more different toxic substances, including heavy metals and chemicals that are harmful to human health and the environment. In some areas, cattle and sheep suffered from diarrhea, decreased fertility, and increased mortality after eating grass polluted with coal ash. It was also found that both surface water and well water around many coal-fired power plants did not satisfy official standards (Si M., 2010. Coal Ash Cloud Looms Large Over China. Inside Climate News (Accessed 24 June 2021)). In India, Khan and Umar conducted experiments around coal ash landfill sites in coal-fired power plants to evaluate the potential impact of coal ash disposal on the quality of soil and groundwater. This study showed that coal ash landfills release toxic elements into the water and soil, resulting in soil and groundwater pollution and health and environmental problems (Khan I., Umar R., 2019. India. Groundw. Sustain. Dev. 8, 346-357). Thus, dealing with the enormous amount of coal ash typically buried in landfills (herein referred to as ‘coal pond ash’) is one of the world's major problems. The only alternative to reducing the amount of coal pond ash is to increase the quality of coal pond ash as a raw material in the resource cycle through any possible pretreatment technology. However, in order to use coal pond ash, the following three need to be confirmed. First, the characteristics of coal pond ash should be examined, because fly ash and bottom ash are mixed together. Second, the characteristics of each coal-fired power plant may affect coal pond ash. Third, because the landfills around coal-fired power plants are located in coastal areas, coal pond ash may be affected by seawater, which is a saline solution containing chloride anions in a large amount (19.344 g/kg Cl) (Ito K. et al., 2009, Comprehensive Handbook of Iodine, pp. 83-91).

Accordingly, the present inventors have made great efforts to solve the above problems and to increase the efficiency of recycling of coal pond ash generated in large amounts from coal-fired power plants, and ascertained that, when simple separation processes including screening, float-sink, flotation, grinding, and magnetic separation are performed under optimal conditions, the efficiency of recycling of coal pond ash increases to a significant level, thus culminating in the present invention.

### SUMMARY OF THE INVENTION

It is an object of the present invention to provide a treatment method of coal pond ash capable of increasing recycling efficiency thereof as a preliminary step before utilization of coal pond ash.

In order to accomplish the above object, the present invention provides a treatment method of coal ash, including (a) classifying coal pond ash into coarse particles, intermediate particles, and fine particles through screening using a sieve, (b) subjecting the fine particles obtained in step (a) to flotation, (c) subjecting the intermediate particles obtained in step (a) to float-sink, and (d) mixing the residue obtained in step (b) with the residue obtained in step (c) and then performing magnetic separation to afford a fine material containing iron oxide and a fine material containing Si and Al.

In addition, the present invention provides a method of obtaining a byproduct having increased purity of unburned carbon (UC) and amorphous compounds (ACs) from coal pond ash (CPA), including (a1) subjecting coal pond ash to screening and recovery, (a2) subjecting coal pond ash to screening, flotation, and recovery, (a3) subjecting coal pond ash to screening, float-sink, grinding, flotation, and recovery, (a4) subjecting coal pond ash to screening, float-sink, magnetic separation, and recovery, (a5) mixing a byproduct obtained through screening, float-sink, primary magnetic separation, and grinding of coal pond ash with the residue obtained in step (a2) and then performing secondary magnetic separation and recovery, or (a6) subjecting the residue obtained in step (a5) to magnetic separation and recovery.

In addition, the present invention provides a method of obtaining a byproduct having increased efficiency of recovery of Fe oxide from coal pond ash (CPA), including (b1) subjecting coal pond ash to screening and recovery, (b2) subjecting coal pond ash to screening, flotation, and recovery, (b3) subjecting coal pond ash to screening, float-sink, and recovery, (b4) mixing a byproduct obtained through screening, float-sink, and grinding of coal pond ash with the residue obtained in step (b2) and then performing magnetic separation and recovery, or (b5) subjecting the residue obtained in step (b4) to magnetic separation and recovery.

In addition, the present invention provides a method of obtaining only Fe oxide from coal pond ash (CPA), including (c1) subjecting coal pond ash to grinding, magnetic separation, and recovery or (c2) subjecting coal pond ash to grinding, primary magnetic separation, secondary magnetic separation, and recovery.

Here, magnetic separation may be additionally performed before grinding in steps (c1) and (c2) in order to reduce energetic cost of the grinding.

In addition, the present invention provides a method of obtaining only unburned carbon and Fe oxide from coal pond ash (CPA), including (d1) subjecting coal pond ash to grinding, flotation, and recovery, (d2) subjecting coal pond ash to grinding, flotation, magnetic sorting, and recovery, or (d3) subjecting coal pond ash to grinding, flotation, primary magnetic separation, secondary magnetic separation, and recovery.

In addition, the present invention provides a method of obtaining a byproduct having increased strength from coal pond ash (CPA), including (e1) subjecting coal pond ash to screening and recovery, (e2) subjecting coal pond ash to screening, flotation, and recovery, or (e3) subjecting coal pond ash to screening, float-sink, and recovery.

### BRIEF DESCRIPTION OF THE DRAWINGS

The above and other objects, features, and other advantages of the present invention will be more clearly understood from the following detailed description taken in conjunction with the accompanying drawings, in which:

FIG. 1 is a map showing the locations of 10 coal-fired power plants (CPPs) and 7 ash ponds (APs) in Korea according to the present invention;

FIG. 2 shows the results of XRD analysis of coal pond ash (CPA) according to an embodiment of the present invention;

FIGS. 3A to 3E show scanning electron microscope (SEM) images of coal pond ash (CPA) according to an embodiment of the present invention: amorphous compounds (ACs) (Al species and glassy phases) (FIG. 3A), coarse particles containing spherical Fe oxide such as Fe₂O₃ and Fe₃O₄ (FIG. 3B), unburned carbon (UC) (FIG. 3C), mullite (FIG. 3D), and quartz (FIG. 3E);

FIGS. 4A and 4B show the weight distribution of unburned carbon (UC) and amorphous compounds (ACs) (including Al species and glassy phases) separated from coal pond ash (CPA) using a float-sink process with various specific gravities (SGs) according to an embodiment of the present invention (FIG. 4A), and XRD patterns thereof (FIG. 4B), in which experimental conditions were as follows: 200 (g/L) of solid/liquid, a reaction temperature of 20° C., a reaction time of 4 hours, a stirring speed of 100 rpm, and CCl₄ and CH₂Br₂ reagents for SG;

FIGS. 5A to 5C show the effect of pH on adsorption kinetics of unburned carbon (UC) according to an embodiment of the present invention (FIG. 5A), the adsorption isotherm of Brunauer-Emmett-Teller (BET) (FIG. 5B), and (Cₒ−C)/C versus Cₒ/(Cₒ−C)U_{sec} (FIG. 5C), in which experimental conditions were as follows: 13 (g/L) of solid/liquid (FIG. 5A) and 6.5, 13, 19.5, 26, 39, and 52 (g/L) of solid/liquid (FIG. 5B), a reaction temperature of 20° C., a reaction time of 60 seconds (FIG. 5A) and 10 seconds (FIG. 5B), an air flow rate of 10 L/min, and 0.5 g/L kerosene and 0.08 g/LMIBC;

FIGS. 6A and 6B show changes in particle size distribution of cold pond ash (CPA) depending on the grinding time according to an embodiment of the present invention (FIG. 6A), and SEM images of CPA (untreated CPA particles (left of FIG. 6B) and CPA particles ground for 20 minutes (right of FIG. 6B));

FIG. 7 is a graph showing changes in the yield (Y_{Fe}) and purity (P_{Fe}) of Fe oxide in iron materials separated using various magnetic forces of 0.1, 0.5, 1, and 2 T;

FIG. 8 is a flow diagram schematically showing a pretreatment process for finally separating byproducts including unburned carbon (UC), Fe oxide, amorphous compounds (ACs) containing Al species (Al₂O₃·xH₂O) and glassy phases, and inorganic materials mainly containing Si and Al, from coal pond ash (CPA); and

FIG. 9 shows various designs of the pretreatment process depending on the types of byproducts.

### DETAILED DESCRIPTION OF THE INVENTION

Unless otherwise defined, all technical and scientific terms used herein have the same meanings as those typically understood by those skilled in the art to which the present invention belongs. In general, the nomenclature used herein is well known in the art and is typical.

In the present invention, a pretreatment method was considered as a preliminary step before utilization of coal pond ash (CPA). This method does not mean that coal pond ash (CPA) may be directly recycled after removing or stabilizing certain harmful substances, but corresponds to an intermediate process including a simple separation method to increase the recycling efficiency of the final recycling process. In order to design a pretreatment method necessary for effective utilization of coal pond ash (CPA), many investigations were conducted using coal pond ash (CPA) samples collected from an ash pond (AP) located near the Boryeong coal-fired power plant (CPP) in Korea. First, the characteristics of the collected samples were investigated based on chemical composition, particle size distribution, X-ray diffraction (XRD) analysis, and scanning electron microscope (SEM) images. Next, a pretreatment method including simple separation processes such as screening, float-sink, flotation, grinding, and magnetic separation was designed depending on the characteristics of coal pond ash (CPA) and experiments were performed to determine optimal conditions for each separation process. Finally, applicability of the pretreatment method to coal pond ash (CPA) in Korea and around the world was also confirmed.

The terms used as abbreviations throughout the specification of the present invention are summarized as follows. Coal ash is referred to as CA, coal-fired power plant as CPP, ash pond as AP, and coal pond ash as CPA.

The present invention intends to provide a method of increasing the utilization of CPA due to the concern about the possibility of environmental pollution around APs in which CA generated from CPPs is buried. Here, the CA buried in APs is regarded as CPA. Also, the characteristics (particle size, weight distribution, chemical composition, unburned carbon (UC) content, particle images, and mineralogical analysis) of CPA were investigated. Moreover, experiments were performed on the main separation processes: float-sink using four different specific gravities (SG) of less than 1.8 SG, 1.8-2.2 SG, 2.2-2.5 SG, and greater than 2.5 SG; flotation in a columnar glass reactor at a pH of each of 2, 7, and 12; grinding using a batch-type ball mill for 5 minutes, 10 minutes, 20 minutes, and 40 minutes; and wet magnetic separation using four magnetic forces (0.1, 0.5, 1, and 2 T). Based on these results, a pretreatment method was proposed, and final byproducts may be classified into UC, amorphous compounds (ACs) containing Al species (Al₂O₃·xH₂O) and glassy phases, inorganic materials containing Si and Al, and iron materials. Six additional pretreatment methods were presented through various combinations of individual separation processes. In addition, it was confirmed that this method is applicable not only to all CPA in Korea, but also to all CPA worldwide.

Accordingly, an aspect of the present invention pertains to a treatment method of CA including (a) classifying CPA into coarse particles, intermediate particles, and fine particles through screening using a sieve, (b) subjecting the fine particles obtained in step (a) to flotation, (c) subjecting the intermediate particles obtained in step (a) to float-sink, and (d) mixing the residue obtained in step (b) with the residue obtained in step (c) and then performing magnetic separation to afford a fine material containing iron oxide and a fine material containing Si and Al.

Hereinafter, a detailed description will be given of the present invention.

In the present invention, in step (a), CPA may be classified into coarse particles having a diameter of greater than 2.36 mm, intermediate particles having a diameter of 0.15-2.36 mm, and fine particles having a diameter of less than 0.15 mm, using standard sieves with grids of 0.15 mm and 2.36 mm.

In the present invention, in step (b), the particles are added with a pH adjuster to obtain the most suitable pH and stabilized, and desired byproducts are obtained through repeated flotation on the water surface, followed by dewatering and drying. Step (b) may be performed at a pH of 7.

There are several factors to consider when performing flotation. First of all, whether a target is wet or not in water is considered. The important medium in flotation is water, and flotation uses the difference between materials that are hydrophilic (easily become wet) and materials that are hydrophobic (do not become wet). The solid to be obtained is made into a solid having a non-wetting surface, and the solid adheres to air bubbles generated in water (wet materials do not adhere to air bubbles), but floats on the water surface by virtue of the ascending force of the air bubbles. When these bubbles are collected and removed, a high-quality byproduct may result. Second, the particle size is considered. During the flotation process, it is important to ensure that all particles are as uniform as possible. If the particle size is not uniform, it is difficult to control the specific gravity. Moreover, the particles have to be sufficiently light to be raised by adhering to the air bubbles, and to have a size that clearly separates target mineral from gangue mineral.

In the present invention, in step (c), float-sink may be performed using a solution with a specific gravity of 2.2.

In the present invention, after step (c), magnetic separation of the resulting residue with a magnetic force of 1.0 T and grinding of a material containing Fe oxide resulting from separation may be further performed.

In the present invention, in step (d), a mixture of the residue obtained in step (b) and the residue obtained in step (c) may be treated using a 0.1 T wet magnetic separator to separate a fine material containing high-purity Fe oxide therefrom, followed by separation of a fine material containing low-purity Fe oxide therefrom using a 1.0 T wet magnetic separator.

In addition, the pretreatment method according to the present invention may be varied through various combinations of individual separation processes, and desired byproducts may be selectively obtained.

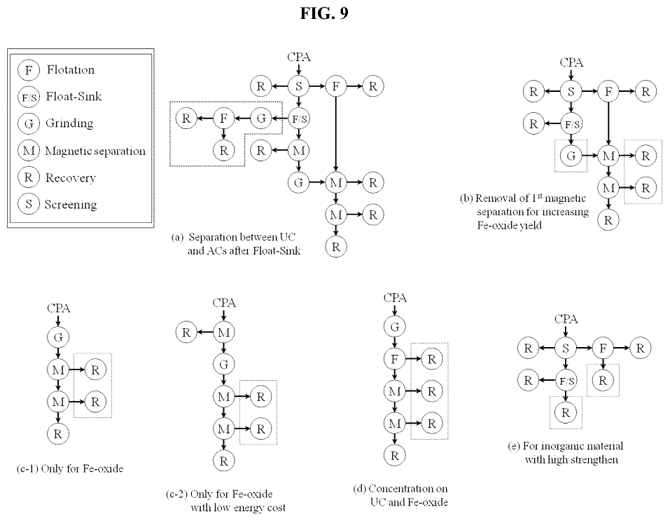

Accordingly, another aspect of the present invention pertains to a method of obtaining a byproduct having increased purity of unburned carbon (UC) and amorphous components (ACs) from CPA, including (a1) screening and recovery of CPA, (a2) screening, flotation, and recovery of CPA, (a3) screening, float-sink, grinding, flotation, and recovery of CPA, (a4) screening, float-sink, magnetic separation, and recovery of CPA, (a5) mixing of the byproduct obtained through screening, float-sink, primary magnetic separation, and grinding of CPA with the residue obtained in step (a2) to afford a mixture, which is then subjected to secondary magnetic separation and recovery, or (a6) magnetic separation and recovery of the residue obtained in step (a5), and this method is shown in FIG. 9A.

Still another aspect of the present invention pertains to a method of obtaining a byproduct having increased efficiency of recovery of Fe oxide from CPA, including (b1) screening and recovery of CPA, (b2) screening, flotation, and recovery of CPA, (b3) screening, float-sink, and recovery of CPA, (b4) mixing of the byproduct obtained through screening, float-sink, and grinding of CPA with the residue obtained in step (b2) to afford a mixture, which is then subjected to magnetic separation and recovery, or (b5) magnetic separation and recovery of the residue obtained in step (b4), and this method is shown in FIG. 9B.

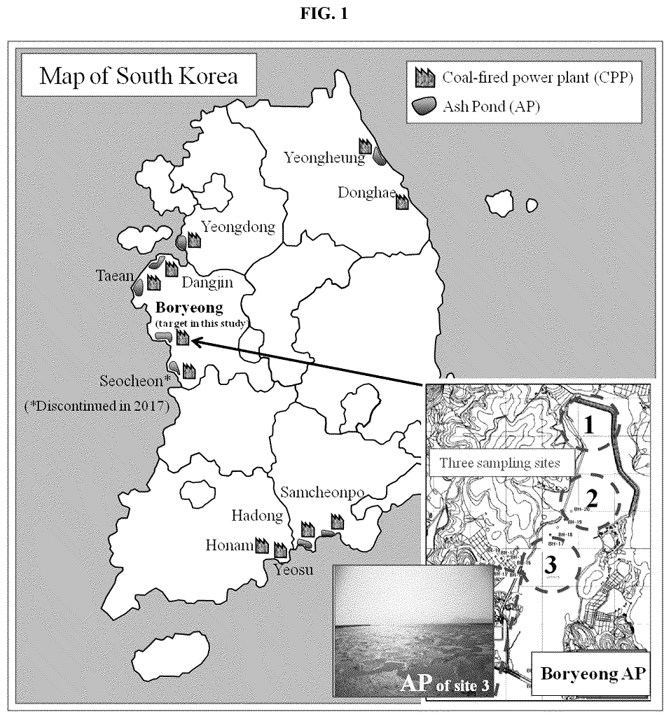

Yet another aspect of the present invention pertains to a method of obtaining only Fe oxide from CPA including (c1) grinding, magnetic separation, and recovery of CPA or (c2) grinding, primary magnetic separation, secondary magnetic separation, and recovery of CPA, and this method is shown in FIG. 9C-1.

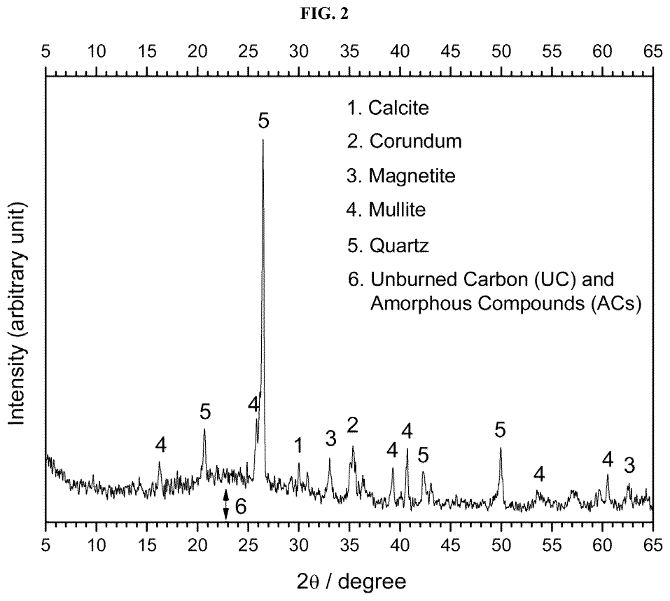

Here, in order to reduce the energetic cost of processing, magnetic separation may be additionally performed before the grinding of steps (c1) and (c2), and this method is shown in FIG. 9C-2.

Still yet another aspect of the present invention pertains to a method of obtaining only unburned carbon and Fe oxide from CPA including (d1) grinding, flotation, and recovery of CPA, (d2) grinding, flotation, magnetic sorting, and recovery of CPA, or (d3) grinding, flotation, primary magnetic separation, secondary magnetic separation, and recovery of CPA, and this method is shown in FIG. 9D.

Even still yet another aspect of the present invention pertains to a method of obtaining a byproduct having increased strength from CPA including (e1) screening and recovery of CPA, (e2) screening, flotation, and recovery of CPA, or (e3) screening, float-sink, and recovery of CPA, and this method is shown in FIG. 9E.

A better understanding of the present invention may be obtained through the following examples. These examples are merely set forth to illustrate the present invention, and are not to be construed as limiting the scope of the present invention, as will be apparent to those of ordinary skill in the art.

### EXAMPLES

CPP located in the Boryeong area, mainly using bituminous coal, was selected, and CPA samples for all experiments were collected from APs located around the selected CPP. A total of nine CPA samples were collected at three sites of the AP as shown in FIG. 1. The weight of each sample was 200 kg. The samples, having various moisture content, were dried at 100° C. for 24 hours and then passed through five standard sieves with grids of 0.15, 0.3, 0.6, 1.18, and 2.36 mm (test sieves, 200×50 mm) to obtain samples having particle sizes of less than 1.15, 0.15-0.3, 0.3-0.6, 0.6-1.18, 1.18-2.36, and greater than 2.36 mm.

### Example 1: Confirmation of Properties of CPA

The chemical composition of CPA and Si, Al, Fe, Ca, Mg, K, Na, Ti, and Mn content were measured using an X-ray fluorescence spectrometer (XRF 3726AI, Rigaku). The unburned carbon (UC) content was determined using the Korean standard LOI method (ES 06303.1) (Ministry of Environment, 2011). Specifically, 20 g of a dewatered sample was heated in an electric furnace at 815° C. for 3 hours and then dried in a desiccator, after which the UC content (w/w %) was determined based on a weight difference before and after LOI. For Cl, the initial content was obtained after dissolution in an acidic solution. The concentration of dissolved Cl after acid degradation was measured using ion chromatography (ICS-3000, Dionex). CPA samples untreated or treated through a certain separation method were measured via XRD (PW3040/00, Philips) in order to identify the mineralogical phase. Also, the surface of the target particles was analyzed using a scanning electron microscope (JEOL).

The particle size distribution, chemical composition, particle images, and mineralogical analysis were investigated in order to confirm the characteristics of CPA collected from the AP near the Boryeong CPP. Table 1 below shows the weight distribution for each particle size, indicating that the weight distribution was as low as 2.5% at a particle size of 1.18 mm or more, and was increased with a decrease in the particle size excluding the range greater than 2.36 mm. In particular, when the particle size was 0.3 mm or less, the weight distribution accounted for 78.2% of the total content. In the chemical composition for each particle size of CPA, Si, Al, Fe, and Ca were main elements, and accounted for 75% or more of the total composition. Among them, silica-based and alumina-based materials were uniformly distributed over the entire particle size. Fe content increased with a decrease in the particle size. For example, Fe content at a particle size of greater than 2.36 mm was <0.1%. However, Fe content at particle sizes of 0.15-0.3 mm and less than 0.15 mm was 15.6% and 18.8%, respectively.

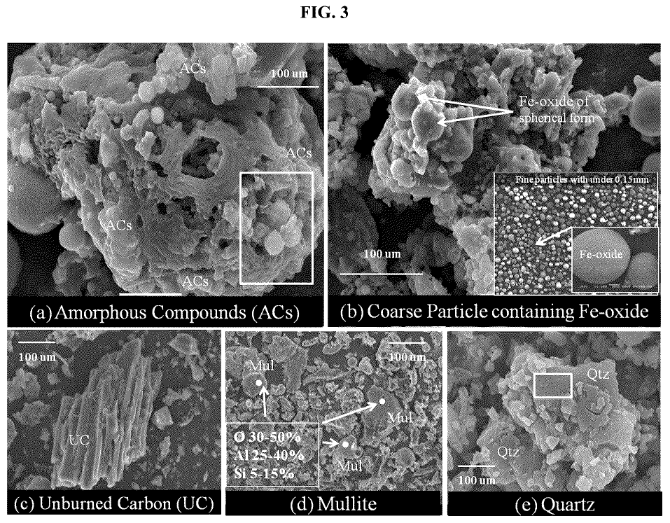

Table 1 below shows the UC content at each particle size. Here, UC is evenly distributed over the entire particle size, and UC content at particle sizes of greater than 2.36 mm and 1.18-2.36 mm was 28.4% (highest) and 9.3% (lowest), respectively. Also, Cl content (mg/kg) in CPA samples having particle sizes of greater than 2.36, 1.18-2.36, 0.6-1.18, 0.3-0.6, 0.15-0.3, and less than 0.15 mm was 42, 74, 112, 184, 273, and 392, respectively. Since the AP around the Boryeong CPP is located near the coast, the CPA may be affected by seawater, which is a saline solution containing chloride anions in a large amount (19.344 g/kg Cl) (Ito K. et al., 2009. Chapter 9—Iodine and Iodine Species in Seawater: Speciation, Distribution, and Dynamics. Comprehensive Handbook of Iodine, pp. 83-91). Most Cl in CA was removed through water washing, based on which it was determined to be soluble chloride. Mullite (3Al₂O₃·2SiO₂), quartz (SiO₂), calcite (CaCO₃), magnetite (Fe₃O₄), and corundum (Al₂O₃) were observed through the XRD patterns of CPA of FIG. 2. These peaks provide evidence that CPA contains Si, Al, Fe, and Ca as main elements, as shown in Table 1. As the x-axis angle moves from 150 to 350, it can be seen that the background peak changes in the form of 22. This provides evidence for the presence of UC (Bartonova L., 2015. Fuel Process. Technol. 134, 136-158; Tai F. C. et al., 2009, J. Raman Spectrosc. 41, 933-937) and amorphous compounds (ACs) containing Al species (Al₂O₃·xH₂O) and glassy phases (Kim B. et al., 2019. The Korean Ceramic Society 56, 365-373; Yan K. et al., 2018, J. Non. Solids 483, 37-42). FIGS. 3A to 3E show SEM images of CPA particles. Of these, FIG. 3A shows ACs on the surface of the CPA particles, and FIG. 3B shows the shape of the CPA containing spherical Fe oxide. When bituminous coal is burned in CPP, the Fe element in coal is dissolved, oxidized, and then aggregated into small spherical particles (Sharonova O. M. et al., 2015, Energy Fuels 29, 5404-5414; Sokol E. et al., 2002. Fuel 81,867-876). In particular, Fe oxide mostly has a particle size of less than 0.15 mm. Because Fe oxide has relatively high strength compared to other CPA materials, Fe oxide retains its spherical shape even after CPA is naturally crushed or pulverized by external impact during transport into APs or landfill therein. It exists independently at a particle size of less than 0.15 mm. Also, FIGS. 3C, 3D, and 3E show UC, mullite, and quartz components, respectively.

Table 1 shows the chemical composition and weight distribution of CPA for each particle size fraction (in which experiments were repeated, each result was obtained in trinlicate and standard deviation of each result was estimated for each case).

TABLE 1

| Particle | | | | | | | | | | | |
|---|---|---|---|---|---|---|---|---|---|---|---|
| size | Weight | Chemical composition (wt. %) | | | | | | | | | |
| (mm) | distribution | SiO₂ | Al₂O₃ | Fe₂O₃ | CaO | MgO | K₂O | NaO₂ | TiO₂ | MnO | UC¹ |
| Over 2.36 | 2.1 | 39.9² | 19.2 | 0.1> | 10.5 | 0.4 | 0.2 | 0.1 | 0.1> | 0.1 | 28.4 |
| 1.18-2.36 | 0.4 | 41.7 | 34.7 | 0.2 | 11.4 | 0.6 | 0.4 | 0.2 | 1.3 | 0.1> | 9.3 |
| 0.6-1.18 | 8.1 | 46.1 | 18.4 | 4.7 | 15.8 | 0.7 | 0.3 | 0.3 | 1.2 | 0.1> | 12.4 |
| 0.3-0.6 | 11.2 | 51.4 | 14.1 | 3.4 | 15.2 | 0.4 | 0.2 | 0.2 | 1.4 | 0.1 | 13.6 |
| 0.15-03 | 37.0 | 40.1 | 11.3 | 15.6 | 10.4 | 0.9 | 0.7 | 0.3 | 1.2 | 0.2 | 19.4 |
| Under 0.15 | 41.2 | 48.4 | 8.5 | 18.8 | 10.1 | 0.8 | 0.4 | 0.5 | 1.7 | 0.3 | 10.5 |

¹Content (w/w %) of unburned carbon (UC) obtained using LOI (loss on ignition) method
²Mean of three values

### Example 2: Pretreatment Process

### 2-1: Float-Sink

All float-sink experiments were performed by adding 120 g of each sample to 600 mL of a solution with each of four different specific gravities (SGs) in a 1 L batch-type glass reactor maintained at 20° C. on a hot plate stirrer. Using a magnetic stirrer equipped with a temperature controller, the mixture was stirred at a stirring speed of 100 rpm for a separation time of 0.5 hours. Four different SGs were prepared by mixing carbon tetrachloride (CCl₄) and dibromomethane (CH₂Br₂) at desired ratios. In the experimental procedure, the first experiment was performed using a solution with 1.8 SG. Then, for the second experiment, the sample precipitated through 1.8 SG was taken and added to a solution with 2.2 SG. Finally, the third experiment was conducted in a solution with 2.5 SG using the sample precipitated through 2.2 SG. After experiments, four byproducts that belonged to the four SG ranges of less than 1.8 SG, 1.8-2.2 SG, 2.2-2.5 SG, and greater than 2.5 SG were ultimately obtained.

### 2-2: Flotation

All flotation experiments were performed by adding a desired amount of each sample to 1 L of a solution in a columnar glass reactor having a diameter of 6 cm and a volume of 1.5 L. The bottom of the reactor was connected to a hose to inject air therein at a flow rate of 10 L/min. A glass filter was provided between the hose and the bottom in order to reduce the size of air bubbles and widely disperse the same. Also, kerosene (0.5 g/L) and MIBC (0.08 g/L) were used to maintain air bubbles for a long time and increase the effect of adsorption of UC to air bubbles. Also, hydrochloric acid (HCl) and sodium hydroxide (NaOH) were used to adjust the pH values to 2, 7, and 12, and thus the effect of pH on flotation was confirmed. In the experimental procedure, an experiment was performed for 60 seconds using 26 g of the sample at each pH in order to confirm the effect of pH on UC adsorption kinetics. Also, in order to confirm the adsorption isotherm of BET (Brunauer-Emmett-Teller), an experiment was performed for 10 seconds using six samples in respective amounts of 6.5, 13, 19.5, 26, 39, and 52 g.

### 2-3: Grinding

All grinding experiments were performed using a batch-type mill (SH-BALL700B, Weus) having a diameter of 200 mm, an inner diameter of 160 mm, and a length of 180 m. Balls having a diameter of about 1.6 mm were packed into the mill with a ratio of the volume of the balls to the volume of the inner space in the mill of 0.4. The sample was then packed into the mill with 1.2 volumes of sample per volume of void space inside the ball-packed mill. Then, grinding was performed by rotating the mill at a critical rotation number of 70% (=42.2/\sqrt{^{mill diameter (mm)-ball diameter (mm)}}) for each grinding time (5, 10, 20, and 40 minutes).

### 2-4: Magnetic Separation

All magnetic separation experiments were performed using a wet magnetic separator (Laboratory High Gradient Magnetic Separator: L-HGMS, DAE BO MAGNETIC CO., LTD.). An electromagnet generating a magnetic field by electric current was placed outside the center of the separator, and the sample was allowed to fall freely and passed through the separator. The magnetic force required for the experiment was maintained at 0.1, 0.5, 1, and 2 T by controlling the electric current.

### Example 3: Effective Separation Process for CPA

Taking into consideration the characteristics of CPA described above, the seven main points for determining the effective separation process were presented in the design of the pretreatment method, and are specified below.

Point 1: CPA is composed of four major byproduct groups including UC, Fe oxide, ACs containing Al species (Al₂O₃·xH₂O) and glassy phases, and inorganic materials containing Si and Al.

Point 2: For particles greater than 2.36 mm in size, UC content is high, and there is almost no Fe content. Therefore, it is possible to obtain coarse particles having high UC content by separating the particles greater than 2.36 mm in size through screening.

Point 3: In CPA, UC and ACs, which have relatively smaller SG values than other materials, may be separated using SG characteristics. Therefore, a float-sink process based on the separation principle using the difference in SG may be considered (Wills B. A. et al., 2016. Wills' Mineral Processing Technology, pp. 245-264). However, for small particles less than 0.15 mm in size, separation efficiency is poor.

Point 4: For particles less than 0.15 mm in size, the UC content is 10.5%, which is not high compared to other CPA particle sizes. However, 41.2% of the total UC content is present in particles less than 0.15 mm in size, which is the highest among the weight distributions of UC. Therefore, for CPA particles smaller than 0.15 mm, UC separation may be the main process. Here, flotation may be considered for the separation process (Eisele T. C. et al., 2010. Miner. Process. Extr. Metall. Rev. 23, 1-10; Zhang R. et al., 2019. Waste Manag. 98, 29-36; Zhou F. et al., 2017. Fuel 190, 182-188).

Point 5: In general, Fe oxide may be easily separated using magnetic separation. Also, as shown in FIGS. 3A to 3E, when spherical Fe oxide having a particle size of less than 0.15 mm is liberated from CPA, the separation effect may be enhanced. Therefore, a grinding process for liberation (less than 0.15 mm) may be conducted before the magnetic separation process.

Point 6: According to points 1, 2, 3, 4, and 5, CPA classification based on the particle size has to be considered in order to increase the efficiency of separation of four major byproduct groups. Thus, three particle size ranges may be designated: greater than 2.36 mm, 0.15-2.36 mm, and less than 0.15 mm.

Point 7: Coastal seawater has an influence on Cl content of CPA during cooling in AP. However, since it is composed mainly of soluble chloride, Cl may be easily removed through simple manipulation of the wet separation process.

The detailed experimental factors for float-sink, flotation, grinding, and magnetic separation were investigated according to the points described above. For float-sink, the GS value for effectively separating UC and ACs was determined. For flotation, the effect of pH on UC separation was confirmed through a BET model with multilayer adsorption between air bubbles and UC particles. Also, grinding and magnetic separation experiments provided the effect of liberation of Fe oxide from CPA after grinding and the yield and purity of Fe oxide separated from CPA with various magnetic forces. The details are described below.

### 3-1: Float-Sink

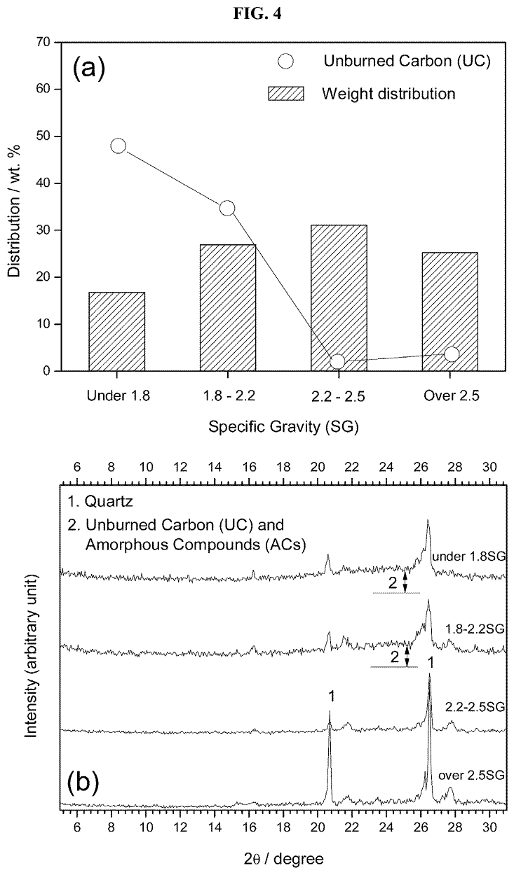

Float-sink was performed with four SG ranges of less than 1.8 SG, 1.18-2.2 SG, 2.2-2.5 SG, and greater than 2.5 SG, and the weight and distribution ratios of UC and ACs including Al species and glassy phases in individual SG ranges were confirmed. Taking into consideration points 1, 4, and 6, CPA having a particle size of 0.15-2.36 mm was selected for this experiment. FIG. 4A shows the weight and distribution of UC in each SG range after float-sink. The numerical value increased with an increase in the SG range (excluding the range greater than 2.5 SG), and thus it was 16.8% (lowest) in the range less than 1.8 SG and 31.1% (highest) in the range of 2.2-2.5 SG. Also, most UC appeared to be distributed in the low SG range, indicating that the UC distribution was 54.7% (highest) in the range less than 1.8 SG, followed by 39.6%, 4.1%, and 1.6% in 1.8-2.2 SG, >2.5 SG, and 2.2-2.5 SG, respectively. FIG. 4B shows changes in the XRD peaks of UC and ACs separated from CPA through float-sink in various SG ranges. This indicates that the UC and AC peaks were observed only in the two XRD patterns in the ranges of 1.8-2.2 SG and less than 1.8 SG, supporting the UC distribution results in FIG. 4A. As is apparent from the results of FIGS. 4A and 4B, the most efficient SG value for separating UC and ACs using float-sink was found to be 2.2 SG.

### 3-2: Flotation

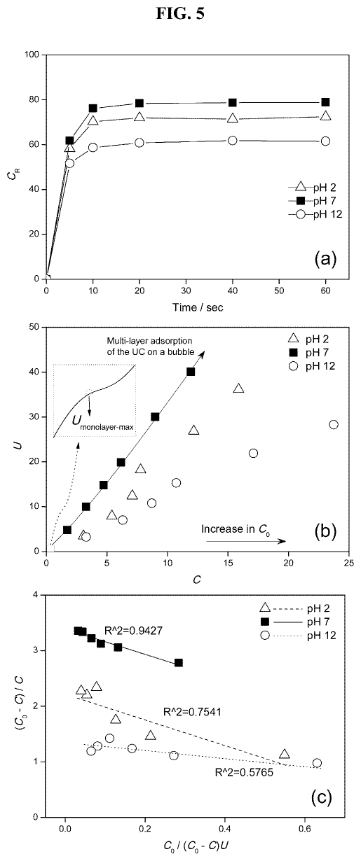

Flotation was performed under various solution conditions at pH values of 2, 7, and 12, and the effect of pH on adsorption kinetics between UC and air bubbles was investigated to confirm the separation of UC. Taking into consideration points 1, 2, and 5, CPA having a particle size of less than 0.15 mm was selected for this experiment. FIG. 5A shows the kinetic curves of UC adsorbed by air bubbles depending on the flotation time. CR represents the UC adsorption (%) after the required flotation time, and may be calculated as follows.

C_{R}=(1−C/C₀)×100 [Equation 1]

Here, C₀ and C respectively represent the initial UC weight (mg) in untreated CPA and the weight (g) of remaining UC (not separated) in CPA after flotation. All curves increased rapidly at the beginning and remained constant after 10 seconds. C_{R} at a pH of 7 was the highest at 78.8%, followed by 70.4% at a pH of 2 and 59.2% at a pH of 12. In the flotation mechanism, UC was adsorbed to the surface of air bubbles created at the bottom of the column system and then floated on the solution. The adsorption between UC and air bubbles may be expressed using the BET adsorption isotherm varied through x (C) and y (U: weight (g) of UC separated through flotation) axes. Also, U may be derived based on k and U_{monolayer-max} as follows (Anderson, R. B., 1946. J. Am. Chem. Soc. 68, 686-691).

U=kU_{monolayer-max}CCₒ/(Cₒ−C)[Cₒ+(k−1)C] [Equation 2]

Here, k and U_{monolayer-max} respectively represent the pre-exponential factor and the maximum weight (g) of UC that may be adsorbed through monolayer adsorption. Indeed, as shown in FIG. 5B, the adsorption isotherm is consistent with the multilayer curve. Equation (2) was rearranged to obtain Equation (3) below.

(Cₒ−C)/C=kU_{monolayer-max}[Cₒ/(Cₒ−C)U]−k [Equation 3]

In the linear form, this equation includes Cₒ/(Cₒ−C)U as the x-axis, (Cₒ−C)/C as the Y-axis, kU_{monolayer-max} as the slope, and −k as the y intercept. Therefore, the values of Cₒ/(Cₒ−C)U calculated based on Cₒ, C, and U were plotted against (Cₒ−C)/C as shown in FIG. 5C. Consequently, the BET model effectively described the adsorption isotherm having an R² value of 0.9427 at a pH of 7. Also, this linear plot showed that the values of k and U_{monolayer-max} were −3.39 and 0.66 (g), respectively. However, the results at pH values of 2 and 12 in FIG. 5C showed fewer effects on the BET adsorption isotherm, which supports the results of adsorption kinetics of UC shown in FIG. 5A. As is apparent from the results of FIGS. 5A to 5C, it was found that the collapse of the BET pattern at pH values of 2 and 12 led to low adsorption kinetics and decreased separation efficiency of UC.

### 3-3: Grinding

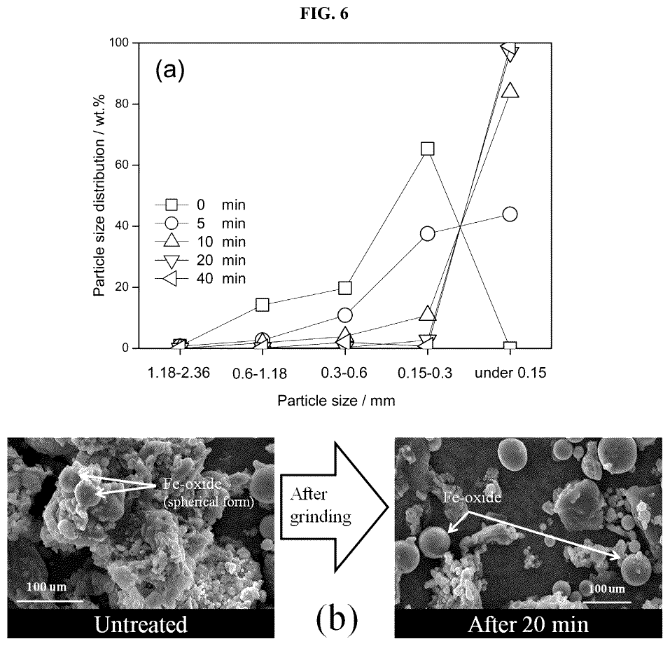

According to point 5, the particles were ground to a particle size of less than 0.15 mm for 5, 10, 20, and 40 minutes. Then, changes in the particle size distribution of CPA depending on the grinding time and the Fe oxide liberation effect were confirmed. Taking into consideration points 1, 2, 5, and 6, CPA having a particle size of 0.15-2.36 mm was selected for this experiment. FIG. 6A shows changes in the particle size distribution of CPA depending on the grinding time. After 20 minutes, most of the particles were ground to <0.15 mm. Also, FIG. 6B shows images of CPA containing Fe oxide before grinding and Fe oxide liberated from CPA after grinding. Since Fe oxide in CPA has relatively high strength compared to other materials, it was not crushed during grinding under the conditions suggested in the section ‘2-3: Grinding’. As is apparent from the results of FIGS. 6A and 6B, grinding was found to affect the Fe oxide liberation.

### 3-4: Magnetic Selection

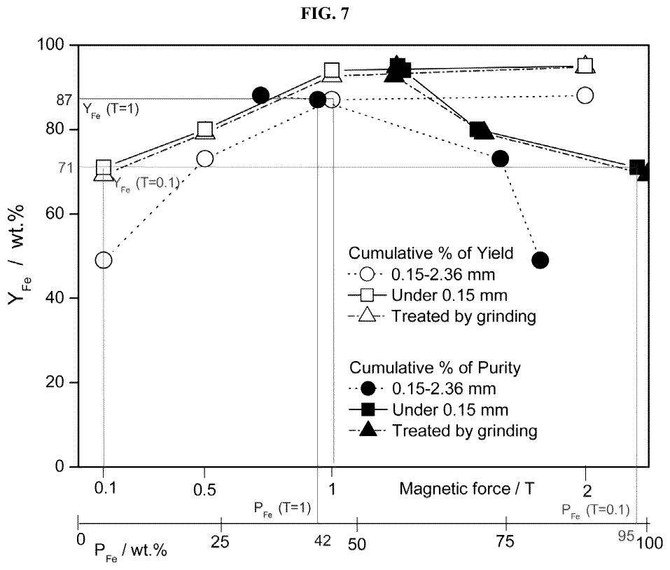

Magnetic separation was performed with four magnetic forces of 0.1, 0.5, 1, and 2 T, and changes in the yield and purity of the Fe oxide that was separated at each magnetic force were confirmed. In order to confirm the effect of magnetic separation on liberated Fe oxide through grinding, three samples were selected in consideration of points 1, 2, 5, and 6 for this experiment. Among the three samples, two are CPAs having particle sizes of 0.15-2.36 mm and less than 0.15 mm, and the remaining one is CPA having a particle size of less than 0.15 mm, which was obtained by grinding CPA particles having a particle size of 0.15-2.36 mm to less than 0.15 mm. FIG. 7 shows changes in the yield (YFe) and purity (PFe) of Fe oxide with various magnetic forces for three samples. Here, Equations (4) and (5) were applied to estimate YFe and Pre using experimental data of F₀, Fᵣ, and Wₜ.

Y_{Fe}=(Fₛ/Fₒ)×100 [Equation 4]

P_{Fe}=(Fₛ/Wₜ)×100 [Equation 5]

Here, Fₒ and Fₛ respectively represent the initial weight (g) of Fe oxide in the untreated sample and the weight (g) of Fe oxide in the material separated through magnetic separation. Wₜ represents the total weight (g) of the material separated through magnetic separation. As shown in FIG. 7, as the strength of the magnetic force increased, the yield of Fe oxide separated through magnetic separation increased, but the purity thereof decreased. For the CPA having a particle size of 0.15-2.36 mm, the yield and purity values at 0.1 T were 49% and 81%, respectively. When increased to 1 T, the yield was increased to 88%, whereas the purity decreased to 32%. In the CPA having a particle size of less than 0.15 mm, the yield and purity at 0.1 T were 71% and 98%, respectively, which were higher than those of the particle size of 0.15-2.36 mm. As the magnetic force increased to 1 T, the yield increased to 95% and the purity decreased to 56%. However, there was no change in the results when the magnetic force was increased from 1 T to 2 T. In contrast, the ground CPA showed almost the same numerical values as those of CPA having a particle diameter of less than 0.15 mm, indicating that grinding increased the magnetic separation effect on Fe oxide.

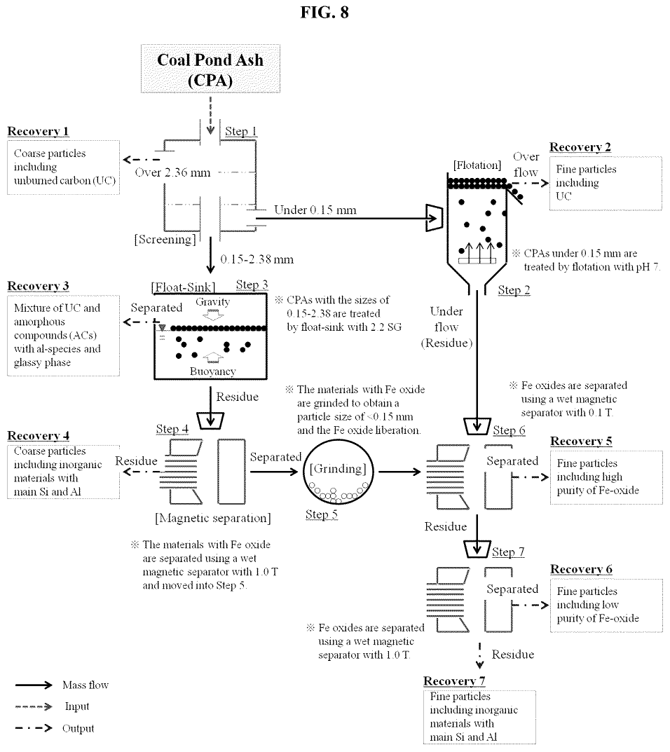

The overall flow diagram (pretreatment process) shown in FIG. 8 was derived using the CPA characteristics, and experimental results were obtained. In this drawing, in step 1, CPA was treated through screening at 2.36 mm and 0.15 mm. As such, wet screening may be applied to remove soluble chloride. In steps 2 and 3, CPA having sizes of 0.15-2.38 mm and less than 0.15 mm was treated through float-sink and flotation, respectively. In step 4, through primary magnetic separation with 1 T (magnetic force), the material containing Fe oxide was separated from the residue after float-sink. Then, the material containing Fe oxide was ground using a mill (step 5). Fe oxide was separated from the residue in step 2 and the material ground in step 5 through secondary (0.1 T) and tertiary (1 T) magnetic separation processes. Consequently, seven byproducts (recoveries 1-7) were ultimately obtained through this pretreatment process. In addition, a laboratory-scale experiment was performed on 200 kg of Boryeong CPA through the designed pretreatment method shown in FIG. 8. Table 2 below shows the separated amounts and chemical compositions of the byproducts (recoveries 1-7) for individual processes in the laboratory-scale experiment. The separated amounts of coarse particles having UC purity of 28.4% in recovery 1 and fine particles having UC purity of 62.1% in recovery 2 were 4.2 kg (2.1%) and 11.0 kg (5.5%), respectively. However, the separated amount of the mixture of UC (purity 37.0%) and ACs in recovery 3 was 49.8 kg (24.8%). For Fe oxide, the separated amounts of fine Fe oxide particles having purities of 94.8% and 42.2% in recoveries 5 and 6 were 23.2 kg (11.6%) and 18.6 kg (9.3%), respectively.

TABLE 2

| | | Separated | Chemical composition (wt. %) | |
|---|---|---|---|---|
| | End material | amount (wt. %) | UC¹ | Fe-oxide |
| Recovery 1 | Coarse particles including UC | 2.1 | 28.4 | 0.1> |
| Recovery 2 | Fine particles including UC | 5.5 | 62.1 | 0.8 |
| Recovery 3 | Mixture of UC and ACs² | 24.8 | 37.0 | 1.2 |
| Recovery 4 | Course particles including | 19.5 | 1.8 | 3.3 |
| | inorganic materials with | | | |
| | main Si and Al | | | |
| Recovery 5 | Fine particles including | 11.6 | 2.1 | 94.8 |
| | high-purity Fe oxide | | | |
| Recovery 6 | Fine particles including | 9.3 | 3.3 | 42.2 |
| | low-purity Fe oxide | | | |
| Recovery 7 | Fine particles including | 27.2 | 2.1 | 2.1 |
| | inorganic materials with | | | |
| | main Si and Al | | | |

¹Unburned carbon
²Amorphous compounds containing Al species (Al₂O₃•xH₂O) and glassy phases

The pretreatment method may be varied through various combinations of individual separation processes. Accordingly, a desired byproduct may be selectively obtained. FIGS. 9A to 9E show various designs of the pretreatment method for the desired byproduct and present some examples. FIG. 9A shows that the mixture of UC and ACs recovered after float-sink may be separated with high purity through additional grinding and flotation. However, the additional processes increase the energetic cost. Also, the process shown in FIG. 9B is capable of increasing the yield of Fe oxide compared to FIG. 8. When the primary magnetic separation is excluded after the float-sink process, the yield of Fe oxide from CPA may be increased through the remaining secondary and tertiary magnetic separation processes. However, this increases the energetic cost of grinding. Two pretreatment methods may be considered in order to maximize the yield of Fe oxide. FIG. 9C-1 shows a process of recovering as much Fe oxide as possible without considering the burden of the high energetic cost of grinding, whereas FIG. 9C-2 shows a process of recovering Fe oxide while lowering dependence on grinding compared to FIG. 9C-1. When considering the separation of UC in FIG. 9C-1, the method shown in FIG. 9D may be designed. Also, the low strength of CA is one of the major problems that prevent application thereof in the construction field (Mangi S. A. et al., 2019. Resources 8(2), 99; Luna Y. L. et al., 2014. Int. J. Energy Environ. Eng. 5, 387-397). Since UC and ACs are materials that lower the strength of CPA, it is possible to obtain an inorganic material having high strength through the separation process of UC and ACs, as shown in FIG. 9E.

The recovered byproducts may be utilized as recyclable materials in various industrial fields through additional physical or chemical processes to meet the quality requirements for final products. For example, UC may be a suitable carbon source for some applications. It may also be used as auxiliary fuel in power plants or incineration facilities, or as an adsorbent having high porosity (Evans M. J. S. et al., 1999. Carbon 37, 269-274; Lee S. et al., 2014. Journal of Korean Inst. of Resources Recycling 23, 40-47). In addition, since natural graphite is regarded as a scarce commodity, it may be a desirable alternative resource in artificial graphite production (Cabielles M. et al., 2008. Energy Fuels 22, 1239-1243; Camean I. et al., 2011. J. Power Sources 196, 4816-4820). Also, ACs containing Al species and glassy phases may be used as raw materials for zeolite, which is an inorganic polymer used as a cation exchanger and adsorbent (Jin X. et al., 2015. Procedia Eng. 121, 961-966; Lee Y. R. et al., 2017. Chem. Eng. J. 317, 821-843; Penilla R. P. et al., 2006. Fuel 85, 823-832). Zeolitized (synthesized) AC may also be used as an immobilization agent, an agent for removing harmful elements from polluted water, and a remediation agent in polluted soil (Fernandez-Pereira C. et al., 2002. J. Chem. Technol. Biotechnol. 77 (Issue 3); Sarkar D. K., 2015. Thermal Power Plant. Elsevier, pp. 139-158; Sarkar M. et al., 2006. Waste Manag. 26, 559-570; Sitarz-Palczak E. et al., 2012. J. Environ. Prot. (Irvine, Calif) 3, 1373-1383).

In order to confirm the current status of CPP and CPA in Korea, the number and location of CPPs, type of combustion, power generation capacity, type of coal used, and AP were investigated. Table 3 below shows the characteristics of 11 CPPs in Korea. It shows that 10 of the 11 CPPs are currently in operation and the remaining one is the Seocheon CPP, which was shut down in 2017.

TABLE 3

| | | | | Ash pond (AP) | | |
|---|---|---|---|---|---|---|
| | Type of | Power generation | | Capacity | CPA amount | |
| CPP¹ | combustion | capacity (MW)² | Coal type | (m)³ | (MT)⁵ | Remark |
| Boryeong | PCC⁴ | 4,000 | Bituminous coal | 23,160,000 | 32.9⁵ | Target material in this study |
| Daoglin | PCC | 6,040 | Bituminous coal | 17,560,000 | 24.9 | |
| Samcheonpo | PCC | 3,240 | Bituminous coal | 13,380,000 | 19.0 | |
| Yeongheung | PCC | 5,080 | Bituminous coal | 10,310,000 | 14.6 | |
| Hadong | PCC | 4,000 | Bituminous coal | 9,220,000 | 13.1 | |
| Taean | PCC | 6,100 | Bkaaninous coal | 7,710,000 | 10.9 | |
| Seocheon | PCC | 200 | Anthracite coal | 6,340,000 | 9.0 | Discontinued in 2017 |
| Yeongdong | PCC | 325 | Anthracite coal | 1,190,000 | 1.7 | |
| Honam | PCC | 500 | Bituminous coal | None | — | |
| Donghae | CFBC⁶ | 400 | Anthracite coal | None | — | |
| Yeosu | CFBC + PCC | 668.6 (CFBC 340) | Bituminous coal | None | — | |

¹Coal-fired power plant
²Megawatt: Equivalent to one million watts (Watt is defined as a derived unit of 1 J/s)
³Million tons
⁴Pulverized coal combustion
⁵CPA amount (MT) = coal pond capacity (m³) × 1,420 kg/m³ (1420 kg/m³ was calculated from references (National Coal Ash Board, 2006; Rhie et al., 2017; Thi et al., 2019) year; U.S. Department of Transportation, 2016))
⁶Circulating fluidized-bed combustion

All CPPs are located in coastal areas so that seawater may be used to cool hot CA generated after combustion. FIG. 1 is a map showing where each CPP is located around the coastal area. The AP-related drawings located near the Boryeong CPP on the map are excerpts from Lee's thesis (Lee S. J. et al., 2007, Geosystem Eng. 10, 47-52). For the type of combustion, most CPPs operate in a pulverized coal combustion (PCC) manner. The Donghae CPP (400 MW) and the Yeosu CPP (340 MW) have been recently constructed and are operating in a circulating fluidized-bed combustion (CFBC) manner. CA generated in the PCC manner is characterized by pozzolan reactivity, and contains glassy aluminosilicates that form at high combustion temperatures (1300° C.-1700° C.) (Cheriaf M. et al., 1999. Cem. Concr. Restns. 29 (9), 1387-1391). This is also consistent with the results of the CPA characteristics (ACs containing Al species and glassy phases) of the PCC-type Boryeong CPP mentioned above. However, CA obtained through CFBC is rich in free CaO and anhydrite due to limestone added during the desulfurization process, and has self-hardening properties (Sheng G. et al., 2012. Fuel 98, 61-66). As for power generation capacity, recently expanded Dangjin (6,040 MW), Yeongheung (5,080 MW), and Taean (6,100 MW) produced high thermal energy, followed by Boryeong (4,000 MW), Hadong (4,000 MW), and Samcheonpo (3,240 MW). Most of the coal used as the main fuel in each CPP is bituminous coal, and only Yeongdong and Donghae, which are small in scale, use anthracite coal. Anthracite coal has a high calorific value due to the high fixed carbon content thereof (85-90%), despite the low volatility thereof (3-7%). However, it is not suitable as a fuel for power generation because of the low combustion rate thereof. In contrast, bituminous coal contains a large amount of volatiles and emits flames. Each CPP operates AP to bury CA, and only small-scale CPPs in Honam, Donghae, and Yeosu entrust landfill treatment to nearby CPPs that operate their own APs. Based on AP capacity and landfill capacity, Boryeong is the largest CPP at 23,160,000 m³ and 32.9 MT, followed by Dangjin (17,560,000 m³ and 24.9 MT) and Samcheonpo (13,380,000 m³ 14.6 MT).

The proposed pretreatment method is based only on CPA in the Boryeong area. Therefore, the separation method and the actual separation material may vary depending on the CPA buried in each AP (a total of seven APs in Korea). However, according to the previous investigation, the overall characteristics of CPA were found to be affected by the combustion type and the type of coal that was used. Most CPPs are operating in a PCC manner and use bituminous coal as the main fuel, and thus, as shown in Table 3, most CPA (92% or more of all CPA in Korea) is expected to have pozzolan reactivity with glassy aluminosilicates and relatively low UC content. Therefore, it can be assumed that CPA buried in AP near Boryeong CPP is typical of all CPA in Korea. It was thought that the CPA in each AP may differ only with regard to the content ratio of each element in the chemical composition. Accordingly, it was predicted that it would not be a problem to apply this pretreatment method to all CPA in Korea. In fact, the mass flow analysis of CPA in the proposed pretreatment method can be estimated using the total amount of CPA buried in all APs in Korea (about 1,517.5 MT, Table 3). After pretreatment, the byproduct containing Fe oxide amounted to 317.1 MT, followed by carbon (115.3 MT), amorphous materials (376.4 MT), and inorganic materials mainly containing Si and Al (708.7 MT).

A large amount of CA is generated from CPPs. Despite government support, strengthened policies, and technical efforts to increase the efficiency of recycling of CA, each CPP continues to dispose of CA in the manner of a landfill by burying the same in a nearby AP. Currently, most APs are full, and local residents are increasingly concerned about the possibility of pollution of the environment around APs. Therefore, in the present invention, in order to properly utilize CPA (representing CA buried in AP), the characteristics of CPA were investigated based on the particle size, weight distribution, chemical composition, UC content, particle images, and mineralogical analysis of CPA. According to these results, a pretreatment method for CPA utilization including screening (standard sieves with grids of 2.38 mm and 0.15 mm), float-sink (2.2 SG), flotation (pH 7), grinding (<0.15 mm), and magnetic separation (0.1 T and 1 T) was designed. Then, seven byproduct groups having different compositions were ultimately obtained depending on the separation method and particle size: (1) coarse particles including UC, separated amount: 2.1 wt %; (2) fine particles including UC, 5.5 wt %; (3) a mixture of UC and ACs, 24.8 wt %; (4) coarse particles, which are inorganic materials mainly containing Si and Al, 19.5 wt %; (5) fine particles including high-purity Fe oxide, 11.6 wt %; (6) fine particles including low-purity Fe oxide, 9.3 wt %; and (7) fine particles, which are inorganic materials mainly containing Si and Al, 27.2 wt %. Also, six additional pretreatment methods were proposed through various combinations of individual separation processes in consideration of the purpose of the desired end material, energetic cost, and recovery efficiency.

It was confirmed that the pretreatment method proposed in the present invention is applicable to domestic CPA. However, since the method according to the present invention is merely an intermediate treatment process for increasing the recycling efficiency in the final recycling process, the potential direction of research for each processing step may be further discussed. Moreover, due to differences in CPA characteristics in many countries, a pretreatment method similar to the present invention has to be developed through a logical review of various CPA characteristics. Nevertheless, the pulverized coal combustion (PCC) method, which is the main method of burning coal, is the most commonly used method in CPPs not only in Korea but also worldwide because it enables the construction of large-scale power plants (Sarkar M. et al., 2005. J. Chem. Technol. Biotechnol. 80 (Issue 12)). Also, according to the global supply structure of coal category by weight by Xia et al., bituminous coal accounts for 73.85% of global coal supply, whereas anthracite coal accounts for 1.38% thereof (Xia X. H. et al., 2017. J. Clean. Prod. 143, 125-144). Therefore, CPPs around the world use bituminous coal as the main fuel. Considering this fact, when most CPA in other countries is compared with the CPA covered in the present invention, it can be predicted that only the content ratios of elements in the chemical composition may differ. Therefore, there will be no problem even when the pretreatment method according to the present invention is applied to CPA in other countries. In addition, when the results obtained in the present invention are directly applied to the same industry in other countries, they may be a basis for designing new pretreatment plants for CA buried in APs or modifying existing designs.

The present invention aims to confirm the possibility of using a recycling strategy beyond the existing simple landfill treatment method. Nationwide, the present inventors expect that the proposed method will bring great benefits with regard to reducing environmental protection costs, including the costs of landfill disposal, maintenance, and periodic environmental monitoring of the environment around APs. Moreover, it can be expected to reduce indirect environmental costs related to activities such as restoration of polluted areas or the economic disadvantages affecting areas around landfill sites. A detailed cost analysis for carrying out these pretreatment methods on a larger scale can be sufficiently obtained through future studies.

### INDUSTRIAL APPLICABILITY

The pretreatment method according to the present invention makes it possible to increase the utilization of coal pond ash, which is generated from coal-fired power plants and is buried in ash ponds, and unburned carbon, amorphous compounds containing Al species (Al₂O₃·xH₂O) and glassy phases, inorganic materials containing Si and Al, and iron materials can be obtained through classification.

In addition, the method of the present invention can be directly applied to the same industry in other countries to provide a basis for designing a new pretreatment plant for coal ash to be buried or to revise an existing design.

Although specific embodiments of the present invention have been disclosed in detail above, it will be obvious to those skilled in the art that the description is merely of preferable exemplary embodiments and is not to be construed as limiting the scope of the present invention. Therefore, the substantial scope of the present invention will be defined by the appended claims and equivalents thereof.

1. A pretreatment method of coal pond ash, comprising:
(a) classifying coal pond ash into coarse particles, intermediate particles, and fine particles by screening using a sieve;
(b) subjecting the fine particles obtained in step (a) to flotation;
(c) subjecting the intermediate particles obtained in step (a) to float-sink; and
(d) mixing a residue obtained in step (b) with a residue obtained in step (c), and then performing magnetic separation to afford a fine material containing Fe oxide and a fine material containing Si and Al.

2. The pretreatment method of coal pond ash of claim 1, wherein, in step (a), the coal pond ash is classified into coarse particles having a diameter of greater than 2.36 mm, intermediate particles having a diameter of 0.15-2.36 mm, and fine particles having a diameter of less than 0.15 mm, using standard sieves with grids of 0.15 mm and 2.36 mm.

3. The pretreatment method of coal pond ash of claim 1, wherein step (b) is performed at a pH of 7.

4. The pretreatment method of coal pond ash of claim 1, wherein, in step (c), float-sink is performed using a solution with a specific gravity of 2.2.

5. The pretreatment method of coal pond ash of claim 1, after step (c), further comprising performing wet magnetic separation of a resulting residue with a magnetic force of 1.0 T and grinding a material containing Fe oxide resulting from separation.

6. The pretreatment method of coal pond ash of claim 1, wherein, in step (d), from a mixture of the residue obtained in step (b) and the residue obtained in step (c), a fine material containing high-purity Fe oxide is separated using a 0.1 T wet magnetic separator and then a fine material containing low-purity Fe oxide is separated using a 1.0 T wet magnetic separator.

7. The pretreatment method of coal pond ash of claim 1, wherein the coal pond ash is generated from a coal-fired power plant and is buried in an ash pond.

8. A method of obtaining a byproduct having increased purity of unburned carbon and amorphous compounds from coal pond ash, comprising:
(a1) subjecting coal pond ash to screening and recovery;
(a2) subjecting coal pond ash to screening, flotation, and recovery;
(a3) subjecting coal pond ash to screening, float-sink, grinding, flotation, and recovery;
(a4) subjecting coal pond ash to screening, float-sink, magnetic separation, and recovery;
(a5) mixing a byproduct obtained through screening, float-sink, primary magnetic separation, and grinding of coal pond ash with a residue obtained in step (a2) and then performing secondary magnetic separation and recovery; or
(a6) subjecting a residue obtained in step (a5) to magnetic separation and recovery.

9. A method of obtaining a byproduct having increased efficiency of recovery of Fe oxide from coal pond ash, comprising:
(b1) subjecting coal pond ash to screening and recovery;
(b2) subjecting coal pond ash to screening, flotation, and recovery;
(b3) subjecting coal pond ash to screening, float-sink, and recovery;
(b4) mixing a byproduct obtained through screening, float-sink, and grinding of coal pond ash with a residue obtained in step (b2) and then performing magnetic separation and recovery; or
(b5) subjecting a residue obtained in step (b4) to magnetic separation and recovery.

10. A method of obtaining Fe oxide from coal pond ash, comprising:
(c1) subjecting coal pond ash to grinding, magnetic separation, and recovery; or
(c2) subjecting coal pond ash to grinding, primary magnetic separation, secondary magnetic separation, and recovery.

11. The method of claim 10, wherein magnetic separation is additionally performed before grinding in steps (c1) and (c2) in order to reduce energetic cost of the grinding.

12. A method of obtaining unburned carbon and Fe oxide from coal pond ash, comprising:
(d1) subjecting coal pond ash to grinding, flotation, and recovery;
(d2) subjecting coal pond ash to grinding, flotation, magnetic sorting, and recovery; or
(d3) subjecting coal pond ash to grinding, flotation, primary magnetic separation, secondary magnetic separation, and recovery.

13. A method of obtaining a byproduct having increased strength from coal pond ash, comprising:
(e1) subjecting coal pond ash to screening and recovery;
(e2) subjecting coal pond ash to screening, flotation, and recovery; or
(e3) subjecting coal pond ash to screening, float-sink, and recovery.
